(19) United States
(12) Patent Application Publication
(10) Pub. No.: US 2021/0318858 A1
(43) Pub. Date: Oct. 14, 2021

(54) METHOD, APPARATUS, AND COMPUTER READABLE STORAGE MEDIUM FOR MONITORING A DATA CHAIN

(71) Applicant: Shenzhen Fugui Precision Ind. Co., Ltd., Shenzhen (CN)

(72) Inventors: QIAN-FAN XU, Shenzhen (CN); QI-MING LUO, Shenzhen (CN); LUNG-SHENG WANG, New Taipei (TW)

(21) Appl. No.: 16/884,425

(22) Filed: May 27, 2020

(30) Foreign Application Priority Data
Apr. 14, 2020 (CN) 202010291677.0

(51) Int. Cl. G06F 8/41; G06F 9/54

(52) U.S. Cl. CPC G06F 8/427; G06F 8/433; G06F 9/54

(57) ABSTRACT

A method for monitoring a data chain comprises the steps of analyzing a source code to generate an abstract syntax tree, traversing the abstract syntax tree to obtain key nodes, and obtaining a data flow dependency relationship. A data chain is formed and graphically presented according to the data flow dependency relationship. The method further utilizes an interceptor to configure intercept points and key indicators at application programming interfaces of the source code, where the key indicators are graphically presented. An apparatus employing the method and a computer-readable storage medium storing the method is also disclosed.

### FIELD

The subject matter herein generally relates to program analysis.

### BACKGROUND

Many businesses are dependent on computer software, industrial applications and the software are constantly emerging or changing. Users also require better software and better user experience.

Any software may need to be upgraded or modified, for many reasons. Therefore, software application development requires high scalability, short cycle time, easy management, and fast response. For application developers, complete and correct logic is always required. Management of a business may require a software application to have a rapid conversion capability. Changes in personnel of a software-based company may result in knowledge being lost and not replaced. Particularly when many codes do not have corresponding development documents and code annotations, codes can only be read and analyzed directly, which greatly reduces efficiency.

Thus, there is room for improvement within the art.

### BRIEF DESCRIPTION OF THE DRAWINGS

Implementations of the present technology will now be described, by way of embodiment, with reference to the attached figures, wherein:

FIG. 1 is a flowchart of one embodiment of a method for monitoring a data chain.

FIG. 2 is a block diagram of one embodiment of an apparatus for monitoring a data chain.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or another storage device. Some non-limiting examples of non-transitory computer-readable media include CDs, DVDs, BLU-RAY, flash memory, and hard disk drives. The term “comprising”, when utilized, means “including but not necessarily limited to”; it specifically indicates open-ended inclusion or membership in a so-described combination, group, series, and the like.

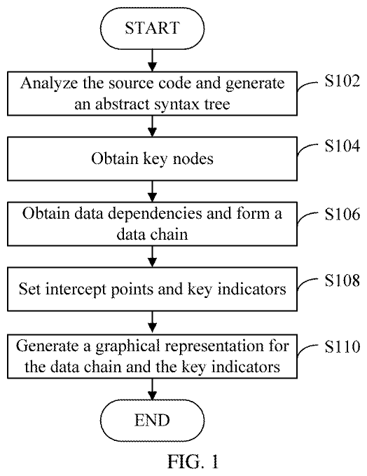

FIG. 1 illustrates a flowchart of a method in one embodiment for monitoring the data chain applied in an apparatus. The method can be implemented in any suitable hardware, software, firmware, or combination thereof.

In step S102, a source code is analyzed to generate an abstract syntax tree of the source code, wherein the abstract syntax tree is a tree-like representation used to describe a syntax structure of the source code. The abstract syntax tree can analyze dependency between classes and classes and indicate relationships, between methods and methods of classes, as well as class annotations and method annotations in the source code.

In one embodiment, the detailed steps of generating the abstract syntax tree comprise lexical analysis and grammatical analysis.

Lexical analysis converts a character stream of the source code into a token list. The token is the smallest element in the programming language, comprising keywords, variable names, literals, operators, and so on. Specifically, the character stream of the source code can be read and merged into a plurality of tokens according to rules to form the token list.

Grammatical analysis is a semantic analysis based on the token list and the grammatical definition of the programming language, and generates the abstract syntax tree corresponding to the source code, according to the grammatical structure of the programming language. Each node in the abstract syntax tree corresponds to one syntactic structure in the source code, for example, classes, modifiers, and operators.

In one embodiment, industry code standards can be applied, to standardize code naming and file path naming to correlate relationships of a data chain in the abstract syntax tree, where naming conventions comprise class name specifications for the classes and annotation specifications for classes and methods.

For example, using a RESTful style to name an external interface of an application programming interface (API) of a background application as “XXXXXController”. The annotations of the classes must comprise “@RestController” and “@API”, where the “@API” is the description of the API. The annotations of the methods of the “XXXXXController” must comprise “@APIOperation”. “XXXXXServiceImpl” classes are used to name all service interaction APIs, and the annotations of the classes must comprise “@Service”. “XXXXXRepository” classes are used to name all databases accessing APIs, and the annotations of the classes must comprise “@Query”. “XXXXXEntity” classes are used to name database entity APIs, and the annotations of the classes must comprise “@Data”, “@Entity”, and “@Table”. The annotations of fields must comprise “@Column”. In one embodiment, “XXXXX” can be a name of a software or a unified naming of a source code.

In step S104, the abstract syntax tree is traversed to obtain key nodes, such as classes, methods, and annotations. In one embodiment, the key nodes may be stored as a list. The key nodes may be stored as a class key node list, a method key node list, and an annotation key node list, depending on the type of the key node, where the lists can comprise index values, which are used to indicate classes and corresponding methods of the classes to each other.

In step S106, a relationship as to data flow dependencies is obtained according to the key nodes, to form a data chain. Specifically, according to all the class names in the class name convention, the class key node list is iterated in turn, the class names of the key nodes that comply with the class naming convention are searched, and then the method key node list is iterated in turn, searching all the key nodes which are corresponding to the search result in the class key node list. The data flow dependency relationship among all key nodes can be obtained in this manner, and a data chain can be formed from the data flow dependency relationship of the key nodes. For example, searching all the key nodes with the class name “Controller” firstly, then searching all the key nodes which are methods and corresponding to the class “Controller”. In this way, searches are done for all the key nodes which have class names of “ServiceImpl”, “Repository” and their corresponding key nodes in the method key node list one by one.

In step S108, an interceptor is used to set a plurality of intercept points at the APIs to intercept APT calls, and configure key indicators for monitoring the data chain. The key indicators are calculated and updated while the software program is running. In one embodiment, the key indicators comprise the names of the plurality of intercept points, input parameters, output results, processing completion running time, and execution times, etc. In one embodiment, the information intercepted by the plurality of intercept points and the key indicators can be stored in a real-time or off-line database, such as KYLIN, HBASE, DRUID, or REDIS database.

Specifically, to dynamically monitor and debug the source code, in one example, an aspect-oriented programming (AOP) feature in the Spring boot framework can be used to implement the interceptor. The use of the AOP interceptor will not destroy the program logic and can isolate the various parts of the business logic, thereby reducing the couplings between the various parts of the business logic.

For example, the plurality of intercept points can be set at the following APIs: the external interface (XXXXXController) of the APIs of the background applications, the APIs (XXXXXServiceImpl) of all service interactions, and the APIs (XXXXXRepository) of accessing a database. The interceptor can intercept the name of each intercept point, records the caller, call parameters, request call time, request return result, request end time, request execution time, and perform calculations and updates accordingly, updating the key indicators such as the name of the intercept point, input parameters, output result, processing completion running time and execution times.

In step S110, a graphical representation for the data chain and the key indicators is generated. In one embodiment, the structure of each key node in the data chain structure is defined firstly as {key node, predecessor node, successor node}, where the predecessor node is used to present the source of the key node in the data flow dependency relationship, and the successor node is used to present the destination of the key node in the data flow dependency relationship. Then, the data chain can be made into graphic form according to the data flow dependency relationship obtained in step S106. Specifically, the graphical representation for the data chain and the data flow dependency relationship can be displayed on a WEB page by using CANVAS (HTML elements). In another embodiment, each key node in the data chain may be used to construct a directed edge according to the data flow dependency relationship obtained in step S106, and accordingly, construct a directed graphic describing the data dependency. In another embodiment, the graphical representation of the key indicators can be displayed according to a user command. For example, for real-time and efficiency data, web socket technology can be used to obtain real-time update data stored in the database in Step S108, and the graphical representation of the key indicators can be displayed according to visual configuration parameters, wherein the visual configuration parameters comprise chart dimension setting, dashboard configuration, and report configuration. In one embodiment, the visual configuration parameters may be a default value or may be set by a user.

The graphical representation of the data chain and the key indicators can in a real-time manner display the data chain and the data flow related to the API call for each request in the software. The graphical representation of the data chain and the key indicators can be used to monitor input parameters and output results of each API, and rapidly check whether the execution result is correct. The graphical representation of the key indicators, for example, the processing completion running time, can also be used to clearly and quickly analyze the processing efficiency for each API in the source code. Finally, the graphical representation of the key indicators, for example, the execution times, can be used to count the real-time access usage of each API in a real-time manner.

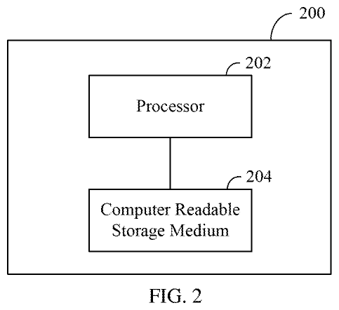

FIG. 2 illustrates an apparatus 200 according to one embodiment. The apparatus 200 can execute the method for monitoring the data chain as shown in FIG. 1. The apparatus 200 comprises a processor 202 and a computer readable storage medium 204. The processor 202 may be a microcontroller, an oscillator, or another circuit with arithmetic processing capability, configured to execute or process instructions, data, and computer programs stored in the computer readable storage medium 204. The computer readable storage medium 204 comprises a read-only memory (ROM), a random access memory (RAM), a magnetic disk storage medium device, an optical storage medium device, a flash memory device, electrical, optical, or other physical/tangible (e.g., non-transitory), etc. The computer readable storage medium 204 is used to store one or more computer programs that control the operation of the apparatus 200 and is executed by the processor 202. In the embodiment, the computer readable storage medium 204 stores or encodes one or more computer programs, and stores model, configuration, and data, for the processor 202, to execute the method shown in FIG. 1. In another embodiment, the apparatus 200 may further comprise a wired or wireless network interface, a keyboard, and an input and output device. The apparatus 200 may also comprise other components for implementing other functions.

In one embodiment, the computer readable storage medium 204 may also be used to store a computer program that, when executed by, for example, the processor 202, may implement the steps of monitoring the data chain method described in any one of the foregoing embodiments. In some implementations, various aspects of the present disclosure may also be implemented in the form of a program product comprising program code.

The method, apparatus, and computer readable storage medium for monitoring the data chain of the present disclosure can classify and visualize the data flow of the software, while generating the data chain. This renders source code adjustment and error checking convenient, by using the key indicators. Compared with the traditional error recording and complete code analysis, the present disclosure offers a clear presentation in a rapid and real-time manner.

The embodiments shown and described above are only examples. Therefore, many details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for monitoring a data chain applied in an apparatus, the method comprising:
analyzing a source code to generate an abstract syntax tree of the source code;
traversing the abstract syntax tree to obtain a plurality of key nodes;
obtaining a data flow dependency relationship according to the plurality of key nodes to form the data chain;
setting a plurality of intercept points at a plurality of application programming interfaces of the source code, and setting a plurality of key indicators; and
generating a graphical representation of the data chain and the plurality of key indicators.

2. The method of claim 1, wherein the plurality of key nodes comprises classes, methods, and annotations.

3. The method of claim 1, wherein the plurality of key indicators comprises names of the plurality of intercept points, input parameters, output result, processing completion running time and execution times.

4. The method of claim 1, wherein the application programming interfaces comprise external interfaces of application programming interfaces of background applications, application programming interfaces of service interactions, and application programming interfaces of accessing a database.

5. An apparatus for monitoring a data chain, the apparatus comprising:
a processing unit; and
a storage unit for storing at least one computer program, wherein the computer program comprises instructions which are executed by the processing unit, and performs a method comprising:
analyzing a source code to generate an abstract syntax tree of the source code;
traversing the abstract syntax tree to obtain a plurality of key nodes;
obtaining a data flow dependency relationship according to the plurality of key nodes to form the data chain;
setting a plurality of intercept points at a plurality of application programming interfaces of the source code, and setting a plurality of key indicators; and
generating a graphical representation of the data chain and the plurality of key indicators.

6. The apparatus of claim 5, wherein the plurality of key nodes comprises classes, methods, and annotations.

7. The apparatus of claim 5, wherein the plurality of key indicators comprises names of the plurality of intercept points, input parameters, output result, processing completion running time and execution times.

8. The apparatus of claim 5, wherein the application programming interfaces comprise external interfaces of application programming interfaces of background applications, application programming interfaces of service interactions, and application programming interfaces of accessing a database.

9. A computer readable storage medium configured to store computer programs which, when executed by a processor, causes the processor to:
analyze a source code to generate an abstract syntax tree of the source code;
traverse the abstract syntax tree to obtain a plurality of key nodes;
obtain a data flow dependency relationship according to the plurality of key nodes to form a data chain;
set a plurality of intercept points at a plurality of application programming interfaces of the source code, and set a plurality of key indicators; and
generate a graphical representation of the data chain and the plurality of key indicators.

10. The computer readable storage medium of claim 9, wherein the plurality of key nodes comprises classes, methods, and annotations.

11. The computer readable storage medium of claim 9, wherein the plurality of key indicators comprises names of the plurality of intercept points, input parameters, output result, processing completion running time and execution times.

12. The computer readable storage medium of claim 9, wherein the application programming interfaces comprise external interfaces of application programming interfaces of background applications, application programming interfaces of service interactions, and application programming interfaces of accessing a database.
